(19) United States
(12) Patent Application Publication
(10) Pub. No.: US 2026/0317145 A1
(43) Pub. Date: Oct. 15, 2026

(54) PRESS-TYPE RIM-CUTTING CAN OPENER

(71) Applicant: Gongping LUO, Guangdong (CN)

(72) Inventor: Gongping LUO, Guangdong (CN)

(21) Appl. No.: 19/283,256

(22) Filed: Jul. 29, 2025

(30) Foreign Application Priority Data
Apr. 10, 2025 (CN) 202510447560.X

(51) Int. Cl. B67B 7/70; B67B 7/46

(52) U.S. Cl. CPC B67B 7/32; B67B 2007/303

(57) ABSTRACT

A press-type rim-cutting can opener includes a main body, a drive unit, and a cutting unit. The drive unit is disposed to extend through the main body, a mounting slot is formed on the main body, and the cutting unit is disposed in the mounting slot and cooperates with the drive unit; the cutting unit includes a cutting wheel, a rubber sleeve, an elastic support tab that are respectively arranged in the mounting slot, and a cutting wheel shaft that is disposed to extend through the mounting slot and is configured to retain the cutting wheel and the rubber sleeve inside the mounting slot; and the elastic support tab is deformed under the action of external force, and then slides from a side of a can rim to an underside of the can rim, thereby supporting a bottom of the can rim.

### CROSS-REFERENCE TO RELATED APPLICATION

This application claims the priority benefit of China application serial no. 202510447560.X, filed on Apr. 10, 2025. The entirety of the above-mentioned patent applications is hereby incorporated by reference herein and made a part of this specification.

### BACKGROUND

### Technical Field

The present disclosure relates to the technical field of household tools, and in particular to a press-type rim-cutting can opener.

### Description of Related Art

In daily life, there are many varieties of canned food, most of which are packaged in tinplate cans. Before the canned food is eaten, sealed lids of the cans must be cut and opened with a cutting tool. Therefore, various can openers have appeared on the market. Rim-cutting can openers are generally divided into two categories: single-handle can openers and double-handle can openers.

Can openers in the prior art usually include a main body, a drive assembly, and a cutting assembly. The drive assembly includes a gear shaft, a shaft sleeve, an inclined wedge sleeve, a pivot pin, and other components. By driving the gear shaft to rotate, the inclined wedge sleeve and the pivot pin cooperate to act on the gear shaft, thereby causing the gear shaft to perform axial movement (FIG. 15), such that a spacing between the drive assembly and the cutting assembly can be adjusted, thereby enabling engagement with and disengagement from the can lid, as disclosed in the Chinese Patent (Publication No.: CN 221070938U) previously filed by the Applicant. However, when a can opener is used to engage with a can lid, the spacing between the drive assembly and the cutting assembly needs to be adjusted by rotating the gear shaft, which is difficult and unfriendly for a novice user to insert the can opener into the can lid, especially when the spacing is adjusted to be small before the can opener is used. Moreover, a large number of assembled components in the drive assembly of the can opener in the prior art results in significant cumulative errors after assembly, leading to low assembly precision unstable quality of the can opener. In addition, the large number of assembled components reduces production efficiency and increases production costs, and finally shortens the service life of the can opener.

### SUMMARY

The present disclosure aims to provide a press-type rim-cutting can opener that is easy to use, and exhibits high assembly precision, low production cost, and long service life.

In order to solve the above technical problems, the present disclosure implements the following technical solution:

A press-type rim-cutting can opener, including a main body, a drive unit, and a cutting unit, where the drive unit is disposed to extend through the main body, a mounting slot is formed on the main body, and the cutting unit is disposed in the mounting slot and cooperates with the drive unit; the cutting unit includes a cutting wheel, a rubber sleeve, an elastic support tab, and a cutting wheel shaft; the cutting wheel, the rubber sleeve, and the elastic support tab are respectively arranged in the mounting slot, and the cutting wheel shaft is disposed to extend through the mounting slot and is configured to retain the cutting wheel and the rubber sleeve inside the mounting slot; and the elastic support tab is deformed under the action of external force, and then slides from a side of a can rim to an underside of the can rim, thereby supporting a bottom of the can rim, in this case, three-point acting force is formed among the elastic support tab, the cutting wheel, and the drive unit to engage with the can rim. The axial movement of the drive unit in the prior art is replaced with a fixed drive unit, the gear disc of the gear shaft is provided with an inclined guide surface, and the cutting unit in the prior art is provided with an elastic support tab. The deformation of the elastic support tab cooperates with the inclined guide surface of the gear disc, such that the can opener in the present disclosure can engage with the can (engage with the can lid) easily and conveniently, facilitating the use of the can opener by a novice user. Moreover, since the drive unit does not need to perform axial movement, components such as a wedge sleeve, a pivot pin, a butterfly spring clip and a spring of the drive unit in the prior art can be eliminated, thereby reducing a total number of assembly components for the can opener. Therefore, cumulative errors during the assembly of the can opener are reduced, the assembly accuracy of the can opener is improved, the stable quality of the can opener is guaranteed, the production efficiency of the can opener is improved, the production cost of the can opener is reduced, and the service life of the can opener is prolonged.

In one embodiment, an insertion slot is formed in the mounting slot, the elastic support tab is inserted into the insertion slot, an inclined surface is formed on an outer side of the insertion slot, and a movement space is formed through the inclined surface, such that the outer ends of the elastic support tab can be deformed in the movement space.

In one embodiment, the drive unit includes a gear shaft, a shaft sleeve, a washer, and a retaining spring, one end of the gear shaft is provided with a gear disc, an inclined guide surface is formed on the gear disc, the other end of the gear shaft is arranged to pass through the main body and extend, a retaining groove is formed at an extension end of the gear shaft, the retaining spring is snapped into the retaining groove to limit a position of the gear shaft, the shaft sleeve is sleeved on the gear shaft and is located at one end of the gear disc, and the washer is located between the retaining spring and the main body.

In one embodiment, an axial direction of the gear shaft is perpendicular to an axial direction of the cutting wheel shaft, and the gear disc on the gear shaft is arranged toward a cutting edge of the cutting wheel.

In one embodiment, the drive unit includes a gear shaft, shaft sleeves, a washer, and a retaining spring, one end of the gear shaft is provided with a gear disc, an inclined guide surface is formed on the gear disc, the other end of the gear shaft is arranged to pass through the main body and extend, a retaining groove is formed at an extension end of the gear shaft, the retaining spring is snapped into the retaining groove to limit a position of the gear shaft, two shaft sleeves are sleeved on the gear shaft, one shaft sleeve is arranged near the gear disc, the other shaft sleeve is arranged near the retaining spring, and the washer is disposed between the other shaft sleeve and the retaining spring.

In one embodiment, an axial direction of the gear shaft and an axial direction of the cutting wheel shaft form an included angle of 12°-16°, and the gear disc on the gear shaft is arranged toward a cutting edge of the cutting wheel.

In one embodiment, a knob is connected to an end of the extension end of the gear shaft, and the knob is in an interference-fit connection with the gear shaft.

In one embodiment, the rubber sleeve and the shaft sleeve are both made of engineering plastic.

In one embodiment, the main body includes a handle, and the main body is further provided with an abutment ring, a boss, and a functional hook.

In one embodiment, the cutting wheel is manufactured by stamping first and then subjected to finish machining with a lathe.

### Beneficial Effects

1. When using the press-type rim-cutting can opener in the present disclosure, the can rim of a can lid is placed in a gap between the drive unit and the cutting unit, the entire can opener is then pressed down, such that outer ends of the elastic support tab of the cutting unit are deformed. During deformation, the elastic support tab cooperates with the cutting wheel and the drive unit to engage with the can rim. The present disclosure implements the can engagement method through the deformation of the elastic support tab to replace the can engagement method through the axial movement of the drive unit in the prior art, which makes the can opener easier and more convenient to use, particularly for a novice user.

2. Since the press-type rim-cutting can opener in the present disclosure implements the can engagement method through the deformation of the elastic support tab to replace the can engagement method through the axial movement of the drive unit in the prior art, components such as a wedge sleeve, a pivot pin, a spring and a butterfly spring of the drive unit in the prior art can be eliminated, thereby reducing a total number of assembly components for the can opener. Therefore, cumulative errors during the assembly of the can opener are reduced, the assembly accuracy of the can opener is improved, the stable quality of the can opener is guaranteed, the production efficiency of the can opener is improved due to the reduction of number of assembly components, the production cost of the can opener is reduced, and the service life of the can opener is prolonged.

### BRIEF DESCRIPTION OF THE DRAWINGS

FIG. 1 is a schematic structural diagram of a press-type rim-cutting can opener according to one embodiment of the present disclosure.

FIG. 2 is an exploded view of a press-type rim-cutting can opener according to one embodiment of the present disclosure.

FIG. 3 is a sectional view of a press-type rim-cutting can opener according to one embodiment of the present disclosure.

FIG. 4 is a schematic diagram of assembly of a gear shaft and an elastic support tab of a press-type rim-cutting can opener according to one embodiment of the present disclosure.

FIG. 5 is a schematic diagram of a main structure of a press-type rim-cutting can opener according to one embodiment of the present disclosure.

FIG. 6 is a schematic diagram of deformation of an elastic support tab of a press-type rim-cutting can opener according to one embodiment of the present disclosure.

FIG. 7 is a schematic structural diagram of a gear shaft of a press-type rim-cutting can opener according to one embodiment of the present disclosure.

FIG. 8 is a first schematic diagram showing a use state of a press-type rim-cutting can opener according to the present disclosure.

FIG. 9 is a second schematic diagram showing a use state of a press-type rim-cutting can opener according to the present disclosure.

FIG. 10 is a schematic structural diagram of a press-type rim-cutting can opener according to another embodiment of the present disclosure.

FIG. 11 is an exploded view of a press-type rim-cutting can opener according to another embodiment of the present disclosure.

FIG. 12 is a schematic diagram of assembly of a gear shaft and an elastic support tab of a press-type rim-cutting can opener according to another embodiment of the present disclosure.

FIG. 13 is a schematic diagram of a main structure of a press-type rim-cutting can opener according to another embodiment of the present disclosure.

FIG. 14 is a schematic structural diagram of a gear shaft of a press-type rim-cutting can opener according to another embodiment of the present disclosure.

FIG. 15 is a schematic diagram showing an engagement state between a drive unit and a cutting unit of a can opener in the prior art.

### DESCRIPTION OF THE EMBODIMENTS

In order to make the above objectives, features and advantages of the present disclosure more apparent and comprehensible, specific embodiments of the present disclosure will be described in detail below in conjunction with the accompanying drawings. Many specific details are set forth in the following description to facilitate thorough understanding of the present disclosure. However, the present disclosure may be implemented in many other ways different from those described herein, similar improvements may be made by those skilled in the art without departing from the connotation of the present disclosure, and therefore the present disclosure is not limited by the specific embodiments disclosed below.

It should be noted that if an element is considered to be “fixed to” the other element, it means that the element may be directly on the other element or indirectly on the other element, or intervening elements may also be present. When an element is considered to be “connected” to another element, the element may be directly connected to another element or there may be an intermediate element simultaneously. In contrast, when an element is referred to as “directly” connected to another element, there is no intermediate element. The terms “vertical,” “horizontal,” “left,” “right,” and the like as used herein are for illustrative purposes only.

Unless otherwise defined, all technical and scientific terms mentioned herein have the same meaning as commonly understood by those skilled in the technical field of the present disclosure. Terms mentioned in the description of the present disclosure are used only for the purpose of describing specific embodiments, and are not intended to limit the present disclosure. As mentioned herein, the term “and/or” includes any and all combinations of one or more relevant listed items.

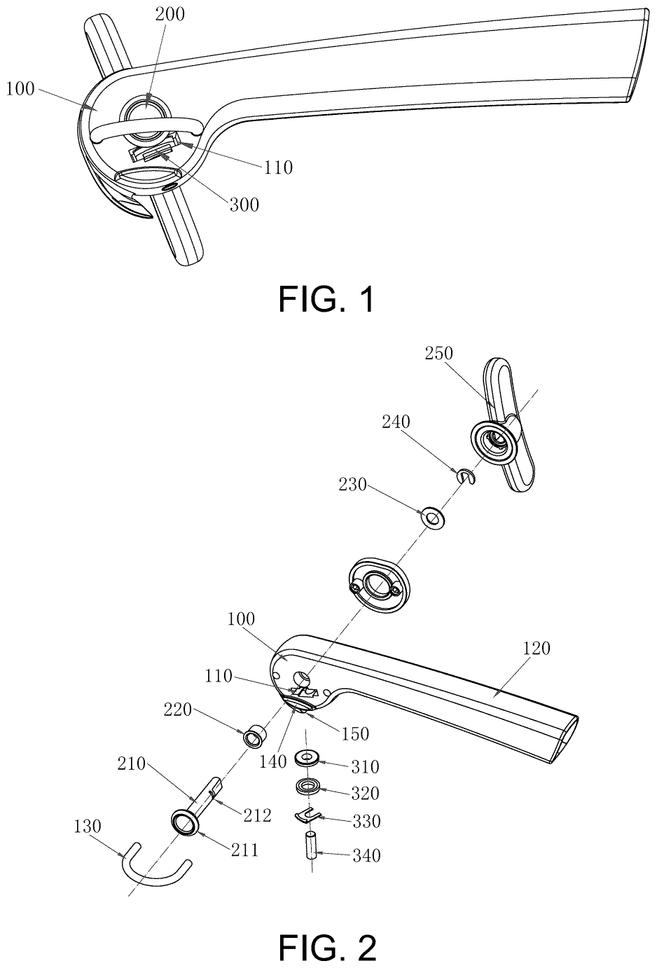

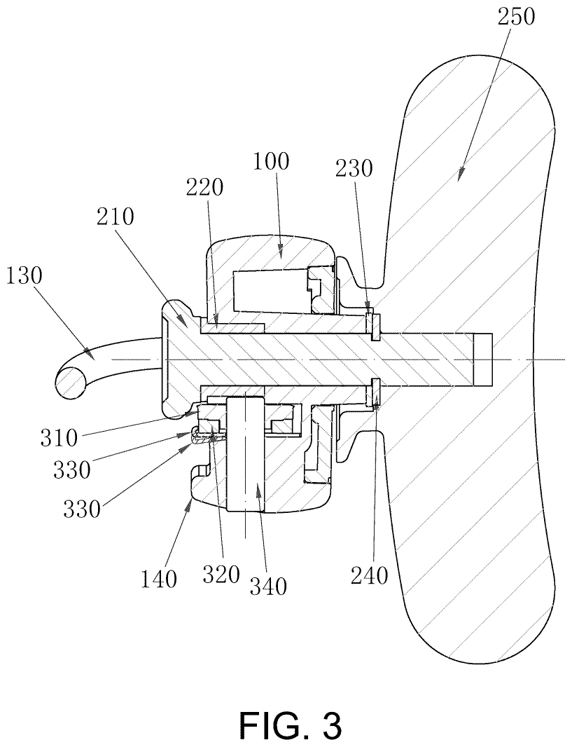

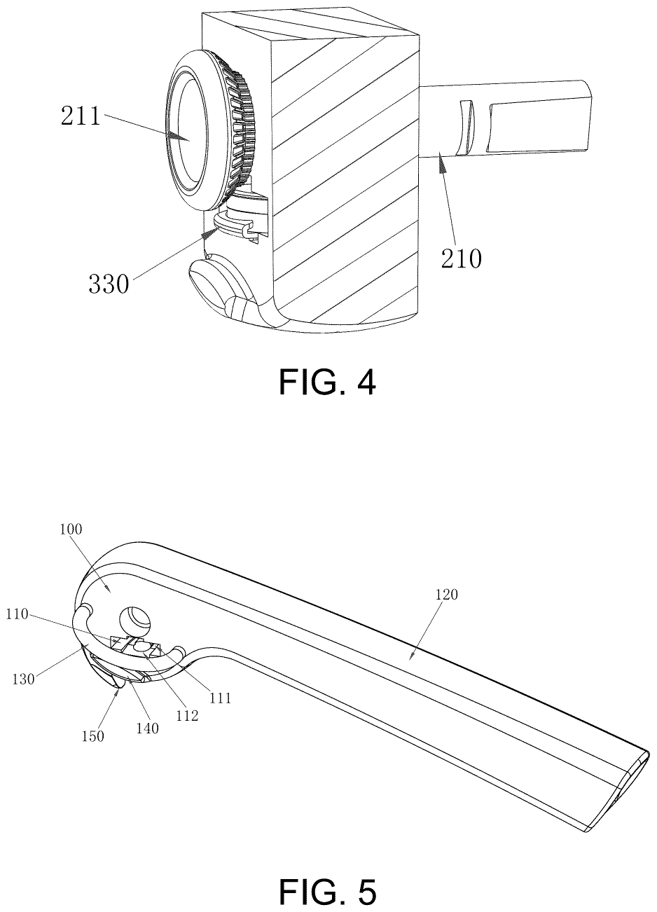

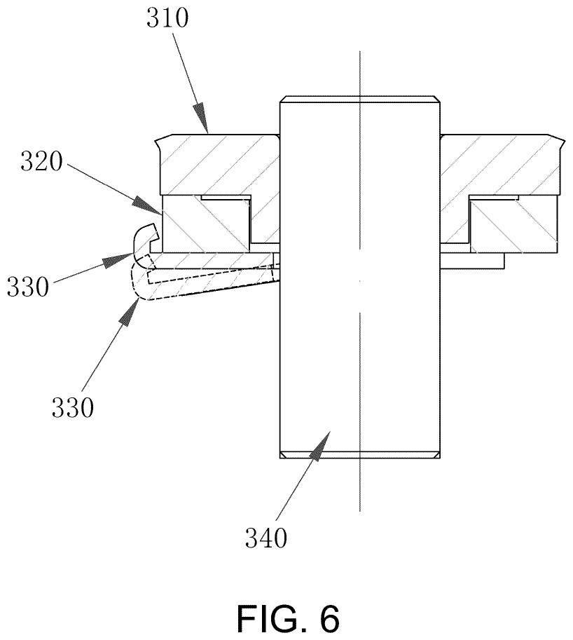

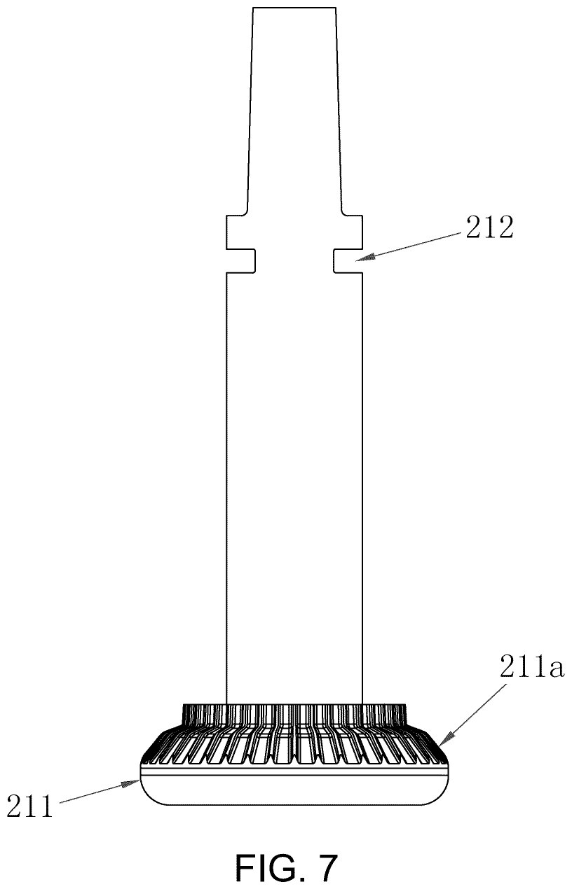

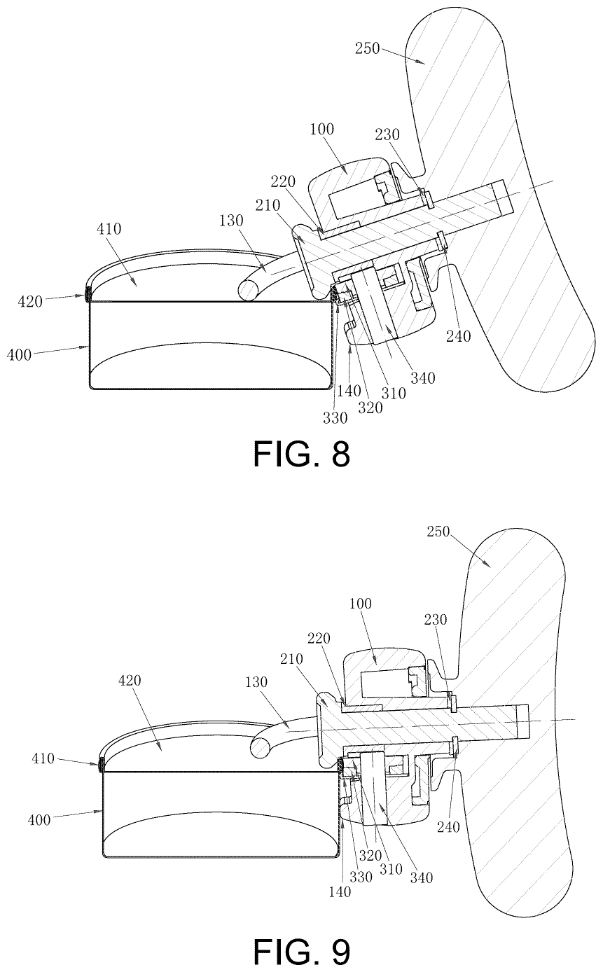

Referring to FIGS. 1-9, a press-type rim-cutting can opener is provided, the can opener includes a main body 100, a drive unit 200, and a cutting unit 300. The drive unit 200 is disposed to extend through the main body 100, a mounting slot 110 is formed on the main body 100, and the cutting unit 300 is disposed in the mounting slot 110 and cooperates with the drive unit 200. The cutting unit 300 includes a cutting wheel 310, a rubber sleeve 320, an elastic support tab 330, and a cutting wheel shaft 340. The cutting wheel 310, the rubber sleeve 320, and the elastic support tab 330 are respectively arranged in the mounting slot 110, the cutting wheel shaft 340 is disposed to extend through the mounting slot 110 and is configured to retain the rubber sleeve 320 and the cutting wheel 310, and the elastic support tab 330 is deformed under the action of external force, and then slides from a side of a can rim 420 to an underside of the can rim 420, thereby supporting a bottom of the can rim 420, in this case, three-point acting force is formed among the elastic support tab 330, the cutting wheel 310, and the drive unit 200 to engage with the can rim 420.

Specifically, when the can opener in this embodiment is in use, the can rim 420 of a can lid 410 is placed in a gap between the drive unit 200 and the cutting unit 300, the entire can opener is then pressed down, such that outer ends of the elastic support tab 330 of the cutting unit 300 are deformed and then spring outward. After springing outward, the outer ends of the elastic support tab 330 are snapped onto the underside of the can rim 420, and cooperate with the cutting wheel 310 and the drive unit 200 to grip the can (engage with the can rim 420 of the can lid 410), such that the drive unit 200 is driven to rotate, the cutting unit 300 is accordingly driven to cut along the can rim 420, and the can lid 410 can be directly removed via the elastic support tab 330 and the drive unit 200 after one full revolution of cutting. Then, the drive unit 200 is driven to rotate in a reverse direction, the cutting unit 300 can be released from the can rim 420, allowing the can lid 410 to fall off automatically. Therefore, the present disclosure implements the can engagement method through the deformation of the elastic support tab 330 to replace the can engagement method through the axial movement of the drive unit in the prior art, the method in the present disclosure makes the can opener easier and more convenient to use, particularly for the novice user.

In addition, since the can engagement method through the deformation of the elastic support tab 330 to replace the can engagement method through the axial movement of the drive unit in the prior art, the drive unit no longer needs to perform the axial movement. As a result, a fixed structure is formed, components such as a wedge sleeve, a spring, a pivot pin, and a butterfly spring of the drive unit in the prior art can be eliminated, thereby reducing a total number of assembly components for the can opener. Therefore, cumulative errors during the assembly of the can opener are reduced, the assembly accuracy of the can opener is improved, the stable quality of the can opener is guaranteed, the production efficiency of the can opener is improved due to the reduction of number of assembly components, the production cost of the can opener is reduced, and the service life of the can opener is prolonged.

In order to facilitate the machining of the cutting unit 300, the cutting wheel 310 in this embodiment is first stamped and then subjected to finish machining with a lathe, such that the cutting wheel 310 can be easily machined, and the production efficiency of the cutting wheel 310 is reduced, and the production cost is reduced. In addition, the rubber sleeve 320 is made of engineering plastic material, which further effectively reduces the production cost.

In addition, referring to FIG. 5, in order to facilitate the use of the can opener by a novice user, the main body 100 is further provided with a handle 120. The handle 120 may be integrally formed with the main body 100 or may be arranged as a separate component, and the user can hold the can opener easily through the handle 120, such that the user can use the can opener better, and the user experience is improved. Further, an abutment ring 130 and a boss 140 are arranged on the main body 100 to facilitate the auxiliary positioning of the can opener against the can body 400 and the can lid 410. Also, the main body 100 is provided with a functional hook 150, and the functional hook 150 is configured to hook and pull the can lid of a pull-tab can and similar products, thereby facilitating the removal of can lid and improving the multifunctionality of the can opener.

Referring to FIGS. 2, 3, and 5, in order to install the elastic support tab 330 and enable the outer ends of the elastic support tab 330 to be deformed, in this embodiment, an insertion slot 111 is formed in the mounting slot 110, the elastic support tab 330 is inserted into the insertion slot 111, an inclined surface 112 is formed on an outer side of the insertion slot 111, and a movement space is formed through the inclined surface 112, such that the outer ends of the elastic support tab 330 can be deformed in the movement space.

By arranging the insertion slot 111 in the mounting slot 110, inner ends of the elastic support tab 330 can be directly inserted, the insertion may be implemented using an interference fit, such that the elastic support tab 330 is placed in the mounting slot 110, and the inclined surface 112 disposed on the outer side of the insertion slot 111 defines the movement space, which can facilitate expansion or resetting of the outer ends of the elastic support tab 330, enabling the deformation of the elastic support tab 330. The deformation of the outer ends of the elastic support tab 330 enables the can opener to insert into the can (engage with the can rim 420 of the can lid 410), such that an overall structural design of the can opener is reasonable. In addition, the elastic support tab 330 may be designed in a “U” shaped form to reduce a deformation area of the elastic support tab 330, such that the outer ends of the elastic support tab 330 can be expanded or reset more smoothly, and the can opener can be deformed without applying greater force when it is pressed, facilitating the use of the can opener by the novice user.

Referring to FIGS. 2, 3, 4 and 7, in one embodiment, in order to enable the drive unit 200 to drive the cutting wheel 310 of the cutting unit 300 to perform circular cutting on the can lid, the drive unit 200 in this embodiment further includes a gear shaft 210, a shaft sleeve 220, a washer 230, and a retaining spring 240. One end of the gear shaft 210 is provided with a gear disc 211, an inclined guide surface 211a is formed on the gear disc 211, the other end of the gear shaft 210 transversely passes through the main body 100 and extends, and the gear disc 211 of the gear shaft 210 is arranged in a direction of the extension end, such that the gear disc 211 cooperates with a cutting edge of the cutting wheel 310. A retaining groove 212 is formed on the extension end of the gear shaft 210, the retaining spring 240 is snapped into the retaining groove 212 to limit a position of the gear shaft 210, the shaft sleeve 220 is sleeved on the gear shaft 210 and is located at one end of the gear disc 211, and the washer 230 is located between the retaining spring 240 and the main body 100.

By arranging the gear shaft 210 to extend transversely through the main body 100, an axial direction of the gear shaft 210 is perpendicular to an axial direction of the cutting wheel shaft 340. The perpendicular configuration enables the can opener to be inserted into the can in a side-pressing manner during use. When the can opener is inserted into the can in the side-pressing manner, the gear disc 211 of the gear shaft 210 needs to be disposed in the direction of its extension end, such that the gear disc 211 cooperates with the cutting edge of the cutting wheel 310 and the elastic support tab 330, thereby ensuring a reasonable structural design of the can opener. Specifically, when the can lid 410 is cut, the gear shaft 210 is driven to rotate. As the gear shaft 210 rotates, the gear disc 211 at the end of the gear shaft rotates along a top of the can rim 420 of the can lid 410, such that the cutting wheel 310 of the cutting unit 300 is driven to perform circular cutting along a sidewall of the can rim 420 of the can lid 410, and cutting and opening the can lid 410 are achieved. Further, the shaft sleeve 220 can effectively improve a stress strength of the gear disc 211, thereby prolonging an overall service life of the gear shaft 210. In addition, the original shaft sleeve 220 made of steel is replaced with the shaft sleeve 220 made of engineering plastic, thereby effectively reducing the production cost. The washer 230 can effectively reduce wear of the retaining spring 240 on the main body 100, thereby prolonging the service life of the can opener.

In addition, in order to facilitate the insertion and opening of the can lid, in this embodiment, the gear disc 211 is provided with an inclined guide surface 211a. When the can opener is used for opening the can lid, the user may apply lateral pressure to the can opener, causing the elastic support tab 330 to deform. During deformation, the elastic support tab 330 cooperates with the inclined guide surface 211a, to facilitate the insertion of the elastic support tab 330 and the gear disc 211 into the can rim 420 of the can lid 410, the gear shaft 210 is driven to rotate, and the cutting wheel 310 of the cutting unit 300 is driven by the rotation of the gear disc 211 to perform circular cutting along the sidewall of the can rim 420 of the can lid 410, thereby cutting to open the can lid of the canned product. The inclined guide surface 211a of the gear disc 211 finally cooperates with the deformation of the elastic support tab 330, such that the user can use the can opener conveniently and simply, thereby making the operation of the can opener friendly to the novice user.

In this embodiment, a specific process of can lid opening is as follows: the can opener is placed on the canned product, the can rim 420 of the can lid 410 is easily placed between the drive unit 200 and the cutting unit 300 through the inclined guide surface 211a of the gear disc 211, the abutment ring 130 abuts against a top of the can lid 410, and the user then presses down on the handle 120. When being pressed down, the elastic support tab 330 is deformed and springs outward under the action of external force, the cutting wheel 310 and the rubber sleeve 320 cut into the sidewall of the can rim 420. When the cut opener is continuously pressed down, the elastic support tab 330 is snapped into the bottom of the can rim 420, the gear disc 211 presses against the top of the can rim 420, the protrusion 140 abuts against a sidewall of the can body 400, such that the gear disc 211 and the elastic support tab 330 are tightly engaged with the can rim of the can lid 410. A knob 250 is then rotated to drive the gear shaft 210 to rotate. As the gear shaft 210 rotates, the gear disc 211 rotates along the top of the can rim 420, and the cutting wheel 310 is driven to perform circular cutting along the sidewall of the can rim 420, such that cutting and opening the can lid 410 are achieved.

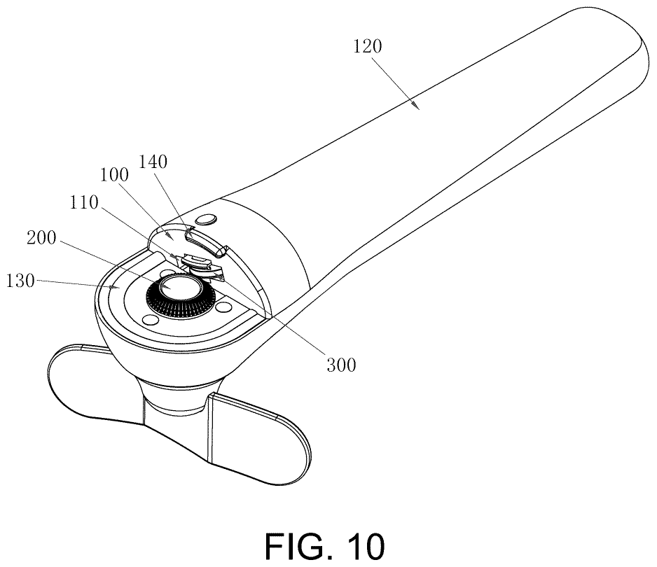

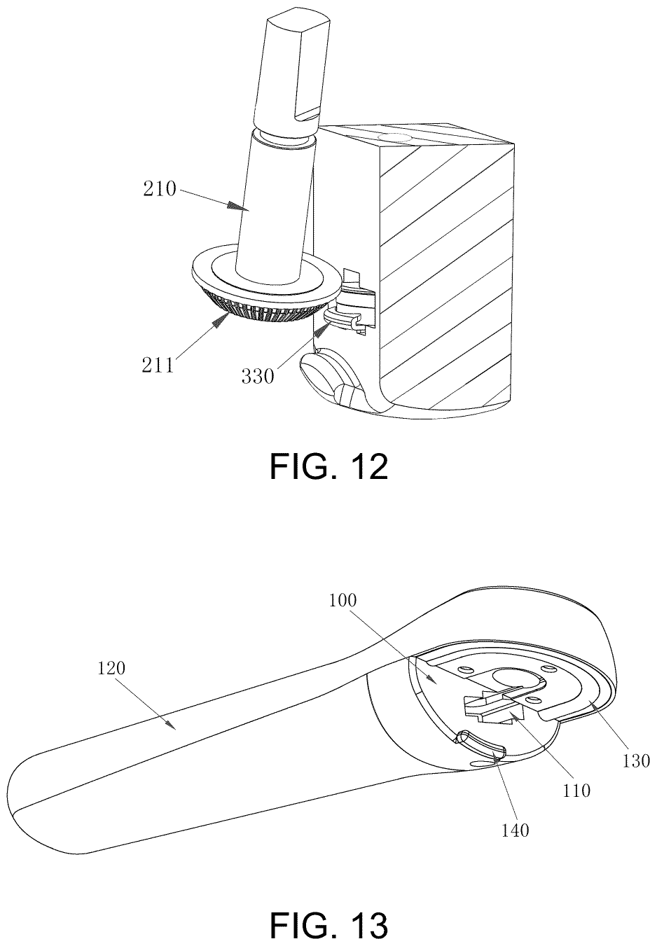

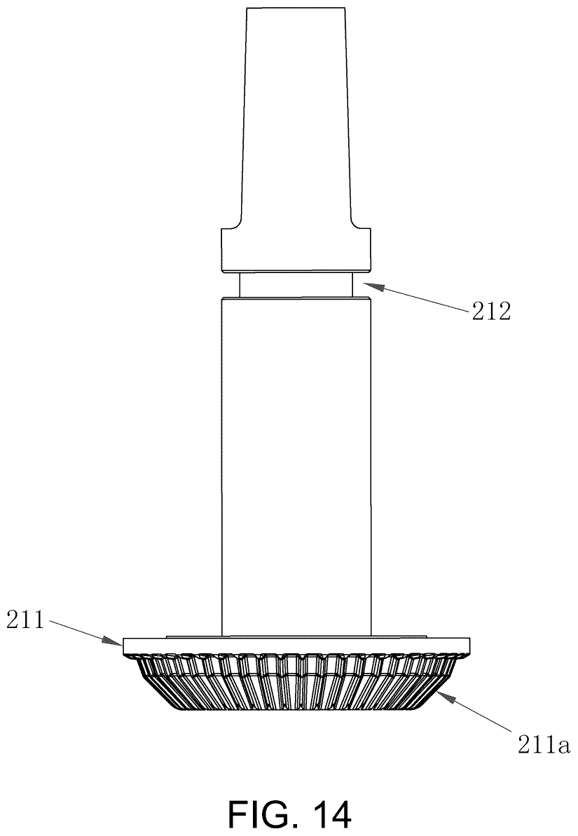

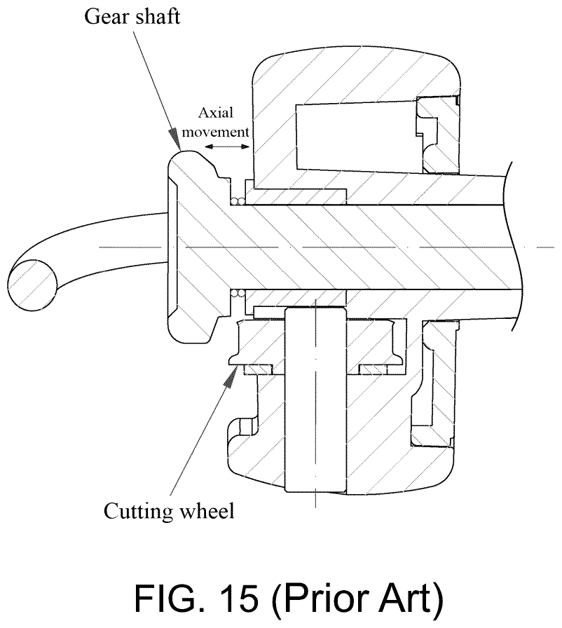

Referring to FIGS. 10-14, in another embodiment, the drive unit 200 is substantially the same as the drive unit 200 in other embodiments. Main differences lie in that: the drive unit 200 in this embodiment includes a gear shaft 210, shaft sleeves 220, a washer 230, and a retaining spring 240. One end of the gear shaft 210 is provided with a gear disc 211, an inclined guide surface 211a is formed on the gear disc 211, the other end of the gear shaft 210 vertically passes through the main body 100 and extends, and the gear disc 211 of the gear shaft 210 is arranged in a direction opposite to the extension end, such that the gear disc 211 cooperates with a cutting edge of the cutting wheel 310. An axial direction of the gear shaft 210 is arranged in a same direction as an axial direction of the cutting wheel shaft 340, a retaining groove 211 is formed on the extension end of the gear shaft 210, the retaining spring 240 is snapped into the retaining groove 211 to limit a position of the gear shaft 210, two shaft sleeves 220 are sleeved on the gear shaft 210, one of the shaft sleeves 220 is arranged near the gear disc 211, the other shaft sleeve 220 is arranged near the retaining spring 240, and the washer 230 is disposed between the other shaft sleeve 220 and the retaining spring 240.

By arranging the gear shaft 210 to extend vertically through the main body 100, the axial direction of the gear shaft 210 and the axial direction of the cutting wheel shaft 340 form an included angle of 12°-16°. The angular configuration enables the can opener to be inserted into the can in a direct-pressing (downward pressing) during use. When the can opener is inserted into the can in the direct-pressing manner, the gear disc 211 of the gear shaft 210 needs to be disposed in the direction opposite to the extension end, such that the gear disc 211 cooperates with the cutting edge of the cutting wheel 310 and the elastic support tab 330, thereby ensuring a reasonable structural design of the can opener, and being convenient for a user (left-handed user) to use the can opener. Similarly, when the can lid 410 is cut, the gear shaft 210 is driven to rotate. As the gear shaft 210 rotates, the gear disc 211 at the end of the gear shaft rotates along a top of the can rim 420 of the can lid 410, such that the cutting wheel 310 of the cutting unit 300 is driven to perform circular cutting of the can rim 420 of the can lid 410, and cutting and opening the can lid 410 are achieved. Further, one of the shaft sleeves 220 can effectively improve a stress strength of the gear disc 211, thereby prolonging an overall service life of the gear shaft 210. In addition, the original shaft sleeve 220 made of steel is replaced with the shaft sleeve 220 made of engineering plastic, thereby effectively reducing the production cost. The washer 230 can effectively reduce wear of the retaining spring 240 on the other shaft sleeve 220, thereby prolonging the service life of the can opener.

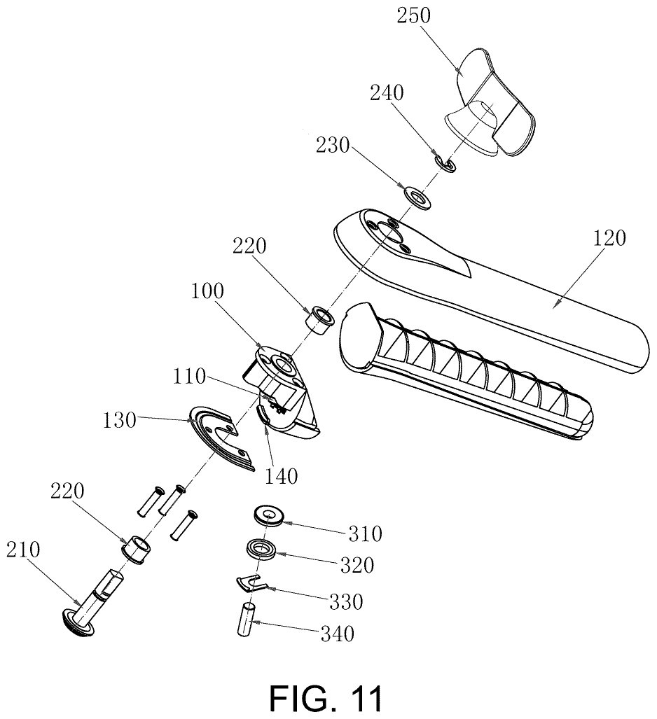

Finally, referring to FIGS. 2 and 11, in order to facilitate the operation of the can opener, a knob 250 is connected to an end of the extension end of the gear shaft 210, the end of the extension section of the gear shaft 210 is shaped into a flattened portion and is interference-fitted into the knob 250, to facilitate the assembly and connection between the gear shaft 210 and the knob 250. Of course, the knob 250 may be in threaded connection with the gear shaft 210, or connected through other means. Through the knob 250, the user can conveniently rotate the gear shaft 210, thereby driving the gear disc 211 at the end of the gear shaft 210 to rotate, and in turn drive the cutting wheel 310 of the cutting unit 300 to perform circular cutting on the can lid 410, thereby facilitating the cutting and opening of the can lid 410.

In summary, the differences between the present disclosure and the prior art are as follows: when opening a can in the prior art, a user needs to first rotate the gear shaft, the pivot pin will act on the inclined wedge sleeve when the gear shaft is driven to rotate, the gear shaft perform an axial movement (1 mm), the axial movement of the gear shaft causes the gear disc to cooperate with the cutting unit to engage with the can rim of the can lid (grip the can rim); the user then continues to rotate the gear shaft, and the gear disc drives the cutting wheel to perform circular cutting of the can lid, such that cutting and opening the can lid are achieved. After the can lid is opened, the user rotates the gear shaft in an opposite direction, the gear shaft performs axial movement in the opposite direction to return to its original position through cooperation of the pivot pin, the inclined wedge sleeve, and the return spring, such that a gap between the gear disc and the cutting unit increased, the cut can lid can be directly removed and discarded. Therefore, in the prior art, the can opener adopts a can engagement mechanism in which the drive unit performs the axial movement and the cutting unit is fixed.

In contrast, in the present disclosure, during the can opening process, the can rim 420 of the can lid 410 is placed between the drive unit 200 and the cutting unit 300, the entire can opener is either laterally pressed or directly pressed down, such that the outer ends of the elastic support tab 330 of the cutting unit 300 spring outward and are deformed. During the deformation, the elastic support tab 330 cooperates with the inclined guide surface 211a of the gear disc 211 on the gear shaft 210 of the drive unit 200 to engage with the can rim (engage with the can rim 420 of the can lid 410). In this case, the driven unit 200 is driven to rotate, which in turn drives the cutting unit 300 to cut the can rim 420 of the can lid 410. After being cut, the can lid 410 may be directly removed and discarded through the cooperation between the elastic support tab 330 and the gear disc 211 of the drive unit 200. Therefore, the can opener in the present disclosure adopts a can engagement mechanism in which the elastic support tab 330 is deformed and the drive unit 200 is fixed.

Finally, the axial movement of the drive unit 200 in the prior art is replaced with a fixed drive unit 200, the gear disc 211 of the gear shaft 210 is provided with an inclined guide surface 211a, and the cutting unit 300 is provided with an elastic support tab 330. The deformation of the elastic support tab 330 cooperates with the inclined guide surface 211a of the gear disc 211, such that the can opener in the present disclosure can engage with the can (engage with the can rim 420 of the can lid 410) easily and conveniently, facilitating the use of the can opener by a novice user. Moreover, since the drive unit 200 does not need to perform axial movement, components such as a wedge sleeve, a pivot pin, a butterfly spring clip and a spring of the drive unit 200 in the prior art can be eliminated, thereby reducing a total number of assembly components for the can opener. Therefore, cumulative errors during the assembly of the can opener are reduced, the assembly accuracy of the can opener is improved, the stable quality of the can opener is guaranteed, the production efficiency of the can opener is improved, the production cost of the can opener is reduced, and the service life of the can opener is prolonged.

What is shown and described above is about basic principles, essential features and advantages of the present disclosure. Those skilled in the art may readily implement the present disclosure based on the accompanying drawings and the foregoing description. However, any equivalent changes, modifications, or variations made by those skilled in the art without departing from the scope of the technical solution of the present disclosure based on the technical content of the present disclosure are all equivalent embodiments of the present disclosure. In addition, any equivalent modifications, alterations, or variations made to the above embodiments based on the essential technical spirit of the present disclosure shall fall within the scope of protection of the technical solution of the present disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A press-type rim-cutting can opener, comprising a main body, a drive unit, and a cutting unit, wherein the drive unit is disposed to extend through the main body, a mounting slot is formed on the main body, and the cutting unit is disposed in the mounting slot and cooperates with the drive unit;
the cutting unit comprises a cutting wheel, a rubber sleeve, an elastic support tab, and a cutting wheel shaft, wherein the cutting wheel, the rubber sleeve, and the elastic support tab are respectively arranged in the mounting slot, and the cutting wheel shaft is disposed to extend through the mounting slot and is configured to retain the cutting wheel and the rubber sleeve inside the mounting slot; and
the elastic support tab is deformed under the action of external force, and then slides from a side of a can rim to an underside of the can rim, a bottom of the can rim is supported, and three-point acting force is formed among the elastic support tab, the cutting wheel, and the drive unit to engage with the can rim.

2. The press-type rim-cutting can opener according to claim 1, wherein an insertion slot is formed in the mounting slot, the elastic support tab is inserted into the insertion slot, an inclined surface is formed on an outer side of the insertion slot, a movement space is formed through the inclined surface, and outer ends of the elastic support tab are deformed in the movement space.

3. The press-type rim-cutting can opener according to claim 1, wherein the drive unit comprises a gear shaft, a shaft sleeve, a washer, and a retaining spring, one end of the gear shaft is provided with a gear disc, an inclined guide surface is formed on the gear disc, the other end of the gear shaft is arranged to pass through the main body and extend, a retaining groove is formed at an extension end of the gear shaft, the retaining spring is snapped into the retaining groove to limit a position of the gear shaft, the shaft sleeve is sleeved on the gear shaft and is located at one end of the gear disc, and the washer is located between the retaining spring and the main body.

4. The press-type rim-cutting can opener according to claim 3, wherein an axial direction of the gear shaft is perpendicular to an axial direction of the cutting wheel shaft, and the gear disc on the gear shaft is arranged toward a cutting edge of the cutting wheel.

5. The press-type rim-cutting can opener according to claim 1, wherein the drive unit comprises a gear shaft, shaft sleeves, a washer, and a retaining spring, one end of the gear shaft is provided with a gear disc, an inclined guide surface is formed on the gear disc, the other end of the gear shaft is arranged to pass through the main body and extend, a retaining groove is formed at an extension end of the gear shaft, the retaining spring is snapped into the retaining groove to limit a position of the gear shaft, two shaft sleeves are sleeved on the gear shaft, one shaft sleeve is arranged near the gear disc, and the other shaft sleeve is arranged near the retaining spring; and the washer is disposed between the other shaft sleeve and the retaining spring.

6. The press-type rim-cutting can opener according to claim 5, wherein an axial direction of the gear shaft and an axial direction of the cutting wheel shaft form an included angle of 12°-16°, and the gear disc on the gear shaft is arranged toward a cutting edge of the cutting wheel.

7. The press-type rim-cutting can opener according to claim 3, wherein a knob is connected to an end of the extension end of the gear shaft, and the knob is in an interference-fit connection with the gear shaft.

8. The press-type rim-cutting can opener according to claim 7, wherein the rubber sleeve and the shaft sleeve are both made of engineering plastic.

9. The press-type rim-cutting can opener according to claim 1, wherein the main body comprises a handle, and the main body is further provided with an abutment ring, a boss, and a functional hook.

10. The press-type rim-cutting can opener according to claim 1, wherein the cutting wheel is manufactured by stamping first and then subjected to finish machining with a lathe.
